(19) United States
(12) Patent Application Publication
(10) Pub. No.: US 2009/0034275 A1
(43) Pub. Date: Feb. 5, 2009

(54) Light-emitting device and heat-dissipating module thereof

(75) Inventors: Chin-Ming Cheng, Taoyuan Hsien (TW); Yu-Ping Hsieh, Taoyuan Hsien (TW); Yi-Sheng Lee, Yaoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/068,508

(22) Filed: Feb. 7, 2008

(30) Foreign Application Priority Data
Jul. 31, 2007 (TW) 96127972

(51) Int. Cl. F21V 29/00

(52) U.S. Cl. 362/373

(57) ABSTRACT

A light-emitting device is provided and includes a circuit, at least one heat-conducting member, a plurality of light-emitting elements, at least one heat-dissipating member and a power supply. The circuit board has at least one trench for the heat-conducting member to be disposed. The plurality of light-emitting element is disposed on the heat-conducting member. The heat dissipating member is disposed on the circuit board and connected to the heat-conducting member. The power supply, is electrically connected with the circuit board to provide the power of the light-emitting elements.

### BACKGROUND OF THE INVENTION

1. Field of the Invention

The invention relates to light-emitting devices and heat-dissipating modules thereof, and in particular, to a light-emitting device and a heat-dissipating module utilizing plural heat pipes and at least one heatsink to dissipate heat.

2. Description of the Related Art

A light-emitting diode with a small size is a point light source. Thus, light emitting diodes have been applied to backlight modules. A light emitting diode array utilized in backlight modules increases optical design flexibility. However, heat dissipation of the light emitting diode array in backlight modules is a challenge. If heat is not dissipated in time, light-emitting quality of the light emitting diode backlight module will be affected. As shown in FIGS. 1 and 2, a conventional method to dissipate heat from an light emitting diode 92 backlight module is by applying a heatsink 93 on the printed circuit board (PCB) 92. A heat pipe 94 is embedded in the heatsink 93 to actively or passively conduct heat to the external atmosphere, as shown in FIG. 3. However, within the heat pipe 94, an evaporation portion and a condensation portion of the heat pipe 94 are not clearly distinguished, such that heat produced from the light emitting diode cannot be fast transmitted to the heatsink 93 through the heat pipe 94 and therefore reduce efficiency of the heat pipe 94. As a result, the conventional method to dissipate heat from an light emitting diode backlight module includes the following disadvantages:
1. Relatively larger usage area, higher costs and heavier weight due to heat dissipation by air convection using large fins on the heatsink 93.
2. Reduced heat dissipating efficiency at the top portion of the fins due to upward convection. Note that the top row and the bottom row of the light emitting diode 91 have a temperature difference of about 10 degrees by simulation.
3. Lack of efficient uniform temperature control of light emitting diode 91 due to the fan motor obstructing air to pass through the center of the heatsink 93 when additional fans are applied to enhance convection.

Therefore, a light-emitting device and a heat-dissipating module thereof are provided to overcome the disadvantages of conventional techniques.

### BRIEF SUMMARY OF THE INVENTION

Accordingly, an object of the present invention is to provide a light-emitting device and a heat-dissipating module thereof to rapidly and uniformly dissipate heat.

The light-emitting device includes a circuit board, at least one heat-conducting member, a plurality of light-emitting element, at least one heat-dissipating member and a power supply. The circuit board has at least one trench for the heat-conducting member to be disposed. The plurality of light-emitting elements is disposed on the heat-conducting member. The heat dissipating member is disposed on the circuit board and connected to the heat-conducting member. The power supply, disposed on the circuit board, connects with the light-emitting element. The invention also discloses a heat-dissipating module of the light-emitting device.

The light-emitting element further includes a heat-conductive metal and a plurality of pins disposed on a side surface of the heat-conducting metal part, wherein the heat-conducting metal part is welded onto the heat-conducting member while the pins respectively contact with corresponding contact pads.

The heat-conducting member is a heat pipe set including a first heat pipe and a second heat pipe. The first heat pipe includes an evaporation portion and a condensation portion extending from the evaporation portion and bent downward and outward relative to the evaporation portion. The second heat pipe includes an evaporation portion and a condensation portion extending from the evaporation and bent downward and inward relative to the evaporation. The condensation portions of the first heat pipe and the second heat pipe connect with the heat-dissipating member.

The heat-dissipating member includes at least one notch to connect the condensation portions of the first pipe and the second pipe. The heat-dissipation member includes a cavity to receive a fan.

The invention discloses a heat-dissipating module including a circuit board, at least one heat-conducting member, a plurality of light-emitting element and at least one heat-dissipating member. The circuit board includes a surface with a wire layout and a plurality of contact pads connected therewith. The contact pads connect the light-emitting element with the wire layout of the circuit board. On the left portion and the right portion of the circuit board, a plurality of parallel arranged longitudinal trenches are formed, respectively. Each trench receives a heat-conducting member. Additionally, the light-emitting elements are disposed on the heat-conducting member. The heat-dissipating member, disposed on a side surface of the circuit board, connects with the heat-conducting member. The power supply is electrically connected with the circuit board for providing power of the light-emitting device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross sectional view of a conventional backlight module;

FIG. 2 is a schematic view of the conventional backlight module;

FIG. 3 is a schematic view of a variant embodiment of the conventional backlight module;

FIG. 4 is a schematic view of a heat-dissipating module of an embodiment of the invention;

FIG. 5 is another schematic view of the heat-dissipating module in FIG. 4;

FIG. 6 is a schematic view of a heat pipe of an embodiment of the invention;

FIG. 7 is an exploded view of the heat-dissipating module of the embodiment of the invention;

FIG. 8 is a cross sectional view of the heat-dissipating module of the embodiment of the invention;

FIG. 9 is a cross sectional view of the heat-dissipating module of a variant embodiment of the invention;

FIG. 10 is a cross sectional view of a light-emitting device of the embodiment of the invention; and

FIG. 11 is a flowchart showing the method of forming the heat-dissipating module of the invention.

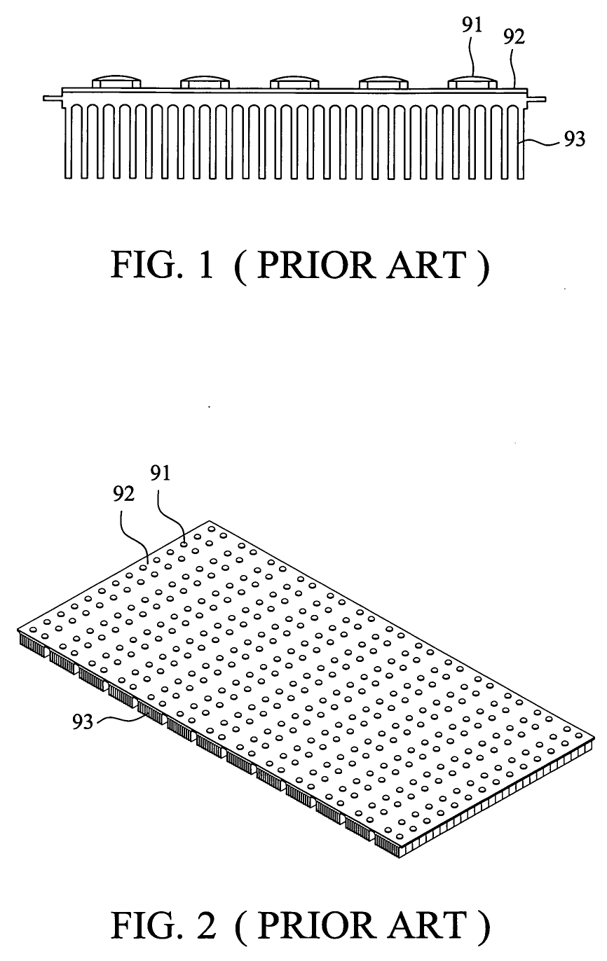

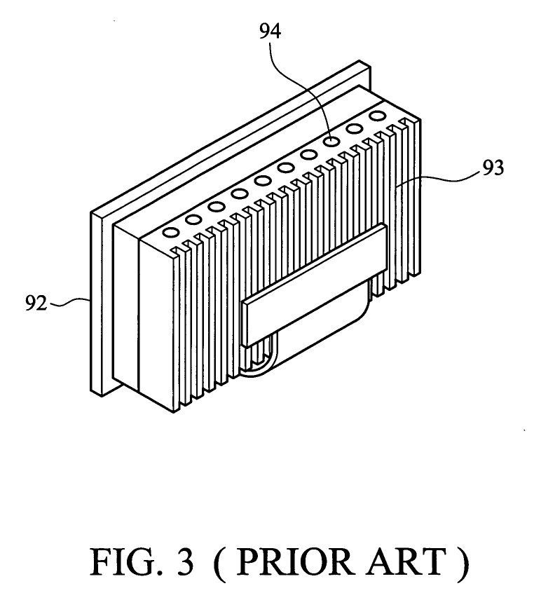

### DETAILED DESCRIPTION OF THE INVENTION

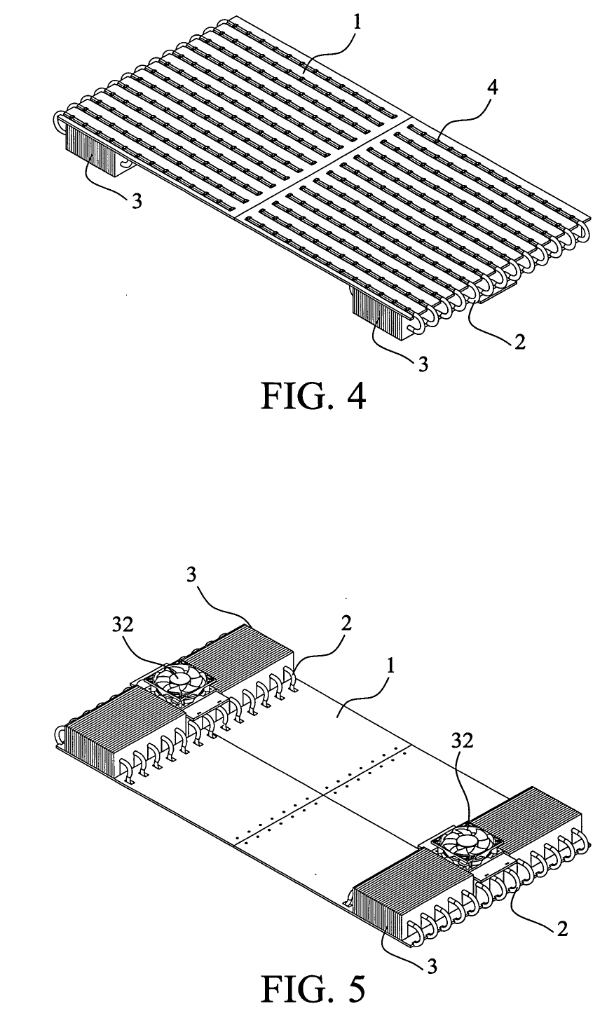

Referring to FIGS. 4 and 5, the invention provides a heat-dissipating module. The heat-dissipating module includes a circuit board 1, a plurality of heat-conducting member, two heat-dissipating members and a plurality of light-emitting elements.

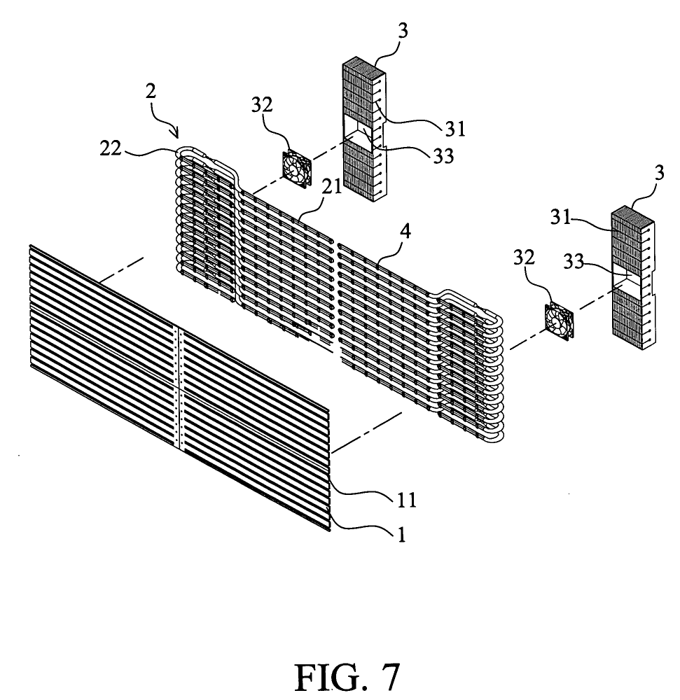

The circuit board 1 of the embodiment is a printed circuit board (PCB) or a low-temperature co-fired ceramic (LTCC) circuit board. The circuit board includes a surface with a wire layout and a plurality of contact pads connected to the wire layout, wherein the pattern of the wire layout is not limited. The wire layout are arranged in series or in parallel. The contacts pads interconnect the light-emitting elements and the wire layout of the circuit board 1. As shown in FIG. 7, on the left portion and the right portion of the circuit board 1, a plurality of parallel arranged longitudinal trenches 11 are formed, respectively. Each trench 11 receives a heat-conducting member.

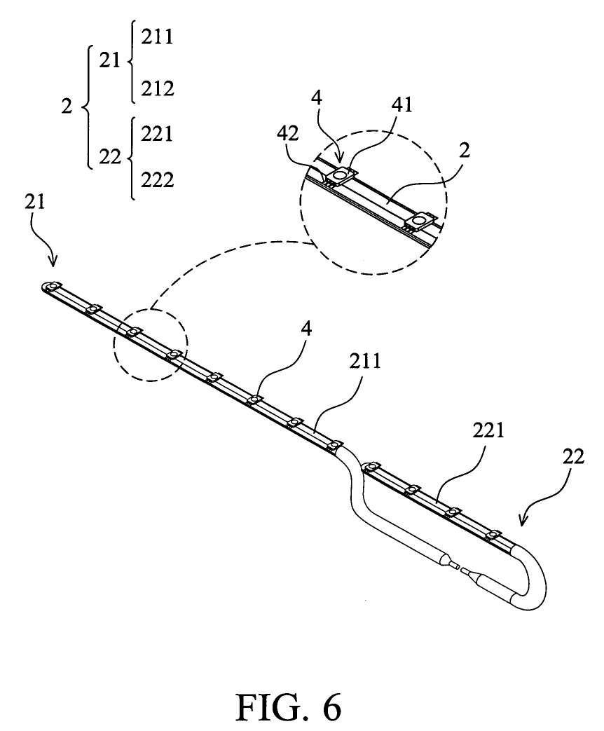

Referring to FIG. 6, the heat-conducting member in the embodiment is preferable to be a heat pipe set 2, such as a pulsating heat pipe set or a loop heat pipe set, and the thermal conductivity thereof is about 6000 W/m·K. The heat pipe set 2 absorbs or transforms heat energy during phase transformation. In detail, the heat pipe set 2 is formed by sealing volatile fluid inside a vacuumed body, wherein the evaporating temperature is close to the ambient temperature. Each heat pipe set 2 includes a first heat pipe 21 and a second heat pipe 22. The first heat pipe 21 includes an evaporation portion 211 and a condensation portion 212 extending from the evaporation portion 211 and bent outward and downward relative to the evaporation portion 211. The second heat pipe 22 includes an evaporation portion 221 and a condensation portion 222 extending from the evaporation portion 221 and bent inward and downward relative to the evaporation portion 211. When the evaporation portions 211, 221 of the heat pipes 21, 22 are heated, the fluid evaporates and gasifies. The gasified vapor flows to the condensation portion 212, 222 on the other end to release heat energy. The vapor is then condensed to the liquid and flows back to the evaporation portion 211, 221 by capillarity. The liquid go round and begin again to achieve heat dissipation. The heat pipe set 2 is suitably applicable to the light-emitting elements with different power, and in particular, is applicable to a high-power light-emitting element.

The heat-dissipating member of the embodiment is a heatsink 3 with a plurality of fins for dissipating heat guided from the heat pipe set 2. Each heatsink 3 includes a plurality of trenches 31, each of which corresponds to a connecting position of the heat pipe set 2. Each trench 31 receives the condensation portions 212, 222 of the first heat pipe 21 and the second pipe 22. When assembled, the evaporation portion 221 of the second heat pipe 22 contacts the surface of the heatsink 3, and levels with the evaporation portion 211 of the first pipe 21. Furthermore, each fan 32 is assembled on each heatsink 3, and each heatsink 3 comprise a cavity 33 to receive the fan 32. The amount of fans may vary according to the heat energy produced by the light-emitting elements.

The light-emitting element of the invention is a light-emitting diode 4, such as a high-power LED (HP LED), a light-emitting diode array (LED Array), an organic light-emitting diode (OLED) or an organic light-emitting diode array (OLED Array). The light emitting diode 4 includes a heat-conducting metal part 41 (slug) and a plurality of pins 42 disposed on the side surface of the heat-conducting metal part 41.

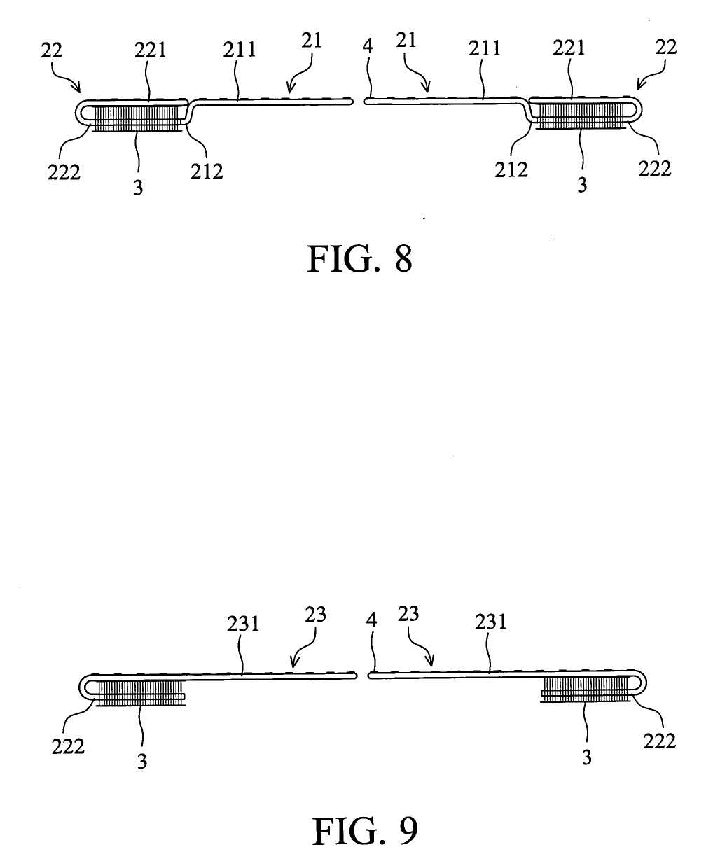

FIGS. 7 and 8 are an exploded view and a cross sectional view of the heat-dissipating module of the invention, respectively. The circuit board 1 includes a left portion and a right portion. Each trench 11 on the left portion and the right portion of the circuit board 1 receives a heat pipe set 2 by embedding, adhesive, soldering or welding. The condensation portions 212, 222 are bent to the backside of the circuit board 1. Left or right portion of the circuit board 1 by first positioning the first heat pipe 21 in the trench 11 on the inner side of the circuit board 1 and positioning the second heat pipe 22 in the trench 11 on the outer side of the circuit board 1, such that the heat pipe sets 2 on the left portion and the right portion are arranged in the opposite directions.

As shown in FIG. 6, in the reflow process the light emitting diodes 4 and the evaporation portions 211, 221 of the first heat pipe 21 and the second heat pipe 22 are connected by surface mounted technology (SMT). The pins 42 of each light emitting diode 4 are connected to the corresponding contact pads by wire bonding. Through the wire layout on the circuit board 1, the light emitting diodes 4 connect with each other in series, in parallel or in combination. Furthermore, filler is utilized to package the light emitting diodes 4 and the contact pads on the circuit board 1. After being packaged, the light emitting diodes 4 are protected from mist or dust for raising the reliability of the light-emitting device and the circuit board 1. Note that the filler can be plastic, resin or silicon rubber, such as epoxy resin or silica gel.

Meanwhile, the condensation portions 22 on two sides of the heat-dissipating module connects with a heat-dissipating member, respectively, wherein the condensation portions 211, 221 of the first heat pipe 21 and the second heat pipe 22 are embedded in the corresponding trenches 31 on the heatsink 33, such that the circuit board 1 including a plurality of heat pipe sets 2 is assembled with two heatsinks 3 on two sides. Each fan 32 is applied to each heatsink 3 to enhance heat dissipating efficiency. The fans 31 applied to the heatsinks 3 produce air stream to raise heat dissipating efficiency. Moreover, the light emitting diode 4 is disposed directly on the heat pipe set 2 for allowing the heat produced thereby to be absorbed directly by the heat pipe set 2, and to be guided to the heatsink 3 through the heat pipe set 2 during operation. Thermal resistance between the light emitting diode 4 and the heat pipe set 2 is thereof reduced.

Referring to FIG. 9, it depicts a cross sectional view of a variant embodiment of the invention. The heat pipe 23, as shown in FIG. 9, includes an evaporation portion 231 and a condensation portion 232 extending from the evaporation portion 231 and bent inward and downward relative to the evaporation portion 231. The light emitting diodes 4 are welded to the evaporation portion 231 by surface mounted technology (SMT), and the condensation portion 23 connects with a heatsink 3. The heat-dissipating module described above includes a simplified heat pipe 23 (on the left and right sides), which requires a shorter first heat pipe 21 and a shorter second heat pipe 22 compared to the heat pipe set 2 in FIG. 8, allowing the application of the heat pipe 23 in a small-sized light-emitting device (such as a small-sized LCD TV).

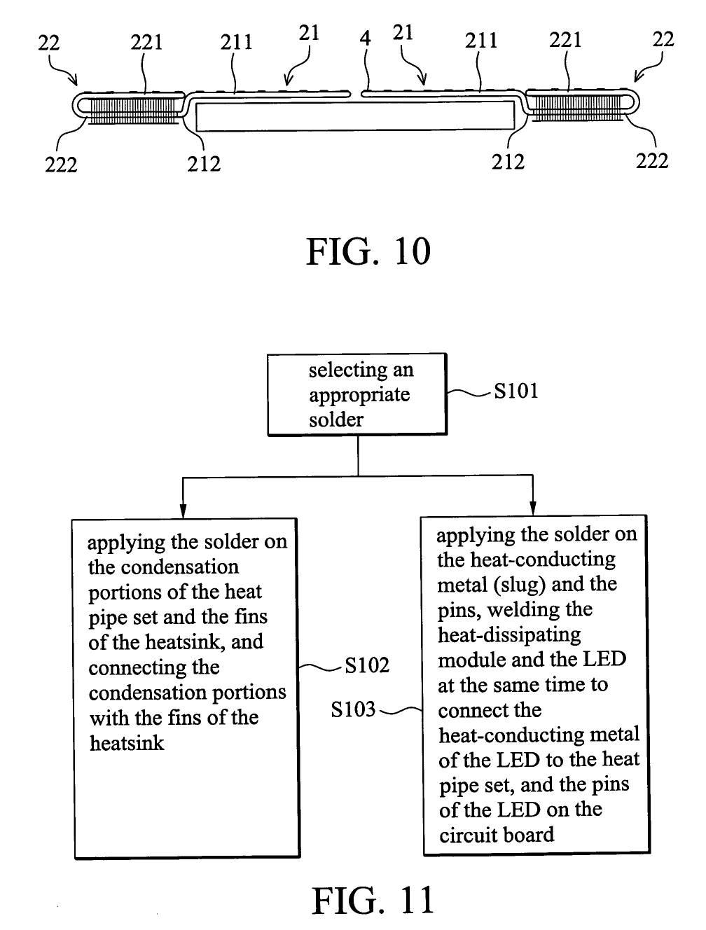

Referring to FIG. 10, a cross sectional view of an embodiment of a light-emitting device of the invention is shown. The light-emitting device includes a heat-dissipating module and a power supply 5. The power supply 5 is disposed on the circuit board 1 between the two heatsinks 3, providing power to the light-emitting device. Such design arrangement efficiently saves spaces.

Referring to FIG. 11, the condensation portions 212, 222 of each heat pipe set 2 connects with the heat-dissipating fins of the heatsink 3 with an appropriately selected solder and temperature resistance. The reflow process includes:
Step S101: selecting an appropriate solder, such as Tin-bismuth solder or other solders;
Step S102: applying the solder on the condensation portions 212, 222 of the heat pipe set 2 and the fins of the heatsink 3, and connecting the condensation portions 212, 222 with the fins of the heatsink 3;
Step S103: applying the solder on the heat-conducting metal part 41 (slug) and the pins 42 for soldering or welding the heat-dissipating module and the light emitting diode 4 at the same time to connect the heat-conducting metal part of the light emitting diode 4 to the heat pipe set 2, and the pins 42 of the light emitting diode 4 on the circuit board 1.

The processing sequence of the step S102 and the step S103 can be switched, and it is not limited thereto.

The heat-conducting metal part 41 of the light emitting diode 4 and the heat pipe set 2 can be connected by, for example, thermal grease, thermal tape, phase change paste, gap filler tape. The focus of the concept is the direct connection between the heat-conducting metal part 41 of the light emitting diode 4 and the surface of the heat pipe set 2 regardless of the connecting method or the material. The pins 42 of the light emitting diode 4 are welded by surface mounted technology, they can be plugged or fixed by a bracket, but it is not limited thereto. The connection therebetween directly connects the heat-conducting metal part 41 of the light emitting diode 4 and the surface of the heat pipe set 2.

The light-emitting element directly contacts the heat-conducting member. During long-term operation, the heat from plural light-emitting elements is conducted through the heat-guiding member. The heat is conducted in the same direction to the condensation portion (cool end) of the heat-conducing member from the evaporation portion (hot end), wherein the heat-conducting member is connected to the light-emitting element, simultaneously, rapidly and uniformly. Then, the heat is conducted to the heat-dissipating member, and then dissipated. The heat-dissipating system dissipates heat fast in a short period of time, sustains temperature uniformity of the circuit board, and further increases the reliability and heat-dissipating efficiency of a light-emitting device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light-emitting device comprising:
a circuit board having at least one trench;
at least one heat-conducting member disposed in the trench;
a plurality of light-emitting elements disposed on the heat-conducting member; and
at least one heat-dissipating member disposed on the circuit board and connected to the heat-conducting member.

2. The light-emitting device as claimed in claim 1, wherein the circuit board is a printed circuit board or a low-temperature co-fired ceramic circuit board.

3. The light-emitting device as claimed in claim 1, wherein the circuit board comprises a wire layout and a plurality of contact pads interconnecting the light-emitting elements and the wire layout of the circuit board.

4. The light-emitting device as claimed in claim 1, wherein the light-emitting element further comprises a heat-conducting metal part connecting with the heat-conducting member and a plurality of pins disposed on a side surface of the heat-conducting metal part and connected with the corresponding contact pads, respectively.

5. The light-emitting device as claimed in claim 4, wherein the heat-conducting metal part connects with the heat-conducting member by soldering, welding, thermal grease, thermal tape, phase change past or gap filler tape.

6. The light-emitting device as claimed in claim 1, wherein the light-emitting element is a light emitting diode, a high-power light emitting diode, a light emitting diode array, organic light emitting diode or organic light emitting diode array.

7. The light-emitting device as claimed in claim 1, wherein the heat-conducting member is disposed in the trench by embedding, adhesive, soldering or welding.

8. The light-emitting device as claimed in claim 1, wherein the heat-conducting member is a heat pipe set comprising a first heat pipe and a second heat pipe, and the heat conducting member is disposed in the trench by positioning the first heat pipe on an inner side of the circuit board and positioning the second heat pipe on an outer side of the circuit board.

9. The light-emitting device as claimed in claim 8, wherein the first pipe further comprises an evaporation portion and a condensation portion extending from the evaporation portion and bent outward and downward relative to the evaporation portion, and the second pipe further comprises an evaporation portion and a condensation portion extending from the evaporation and bent inward and downward relative to the evaporation portion.

10. The light-emitting device as claimed in claim 9, wherein the heat-dissipating member comprises a notch to connect with the condensation portion.

11. The light-emitting device as claimed in claim 9, wherein the condensation portions of the first pipe and the second pipe connect with the heat-dissipating member.

12. The light-emitting device as claimed in claim 1, wherein the heat-conducting member is a heat pipe, and the heat pipe comprises an evaporation portion and a condensation portion extending from the evaporation portion and bent inward and downward relative to the evaporation portion and connecting with the heat-dissipating member.

13. The light-emitting device as claimed in claim 12, wherein the heat-dissipating member comprises a notch to connect with the condensation portion.

14. The light-emitting device as claimed in claim 1, wherein the heat-conducting member is a pulsating heat pipe or a loop heat pipe, and the heat-conducting member has a thermal conductivity of about 6000 W/m·K.

15. The light-emitting device as claimed in claim 1, wherein the heat-dissipating member comprises a cavity to receive a fan.

16. The light-emitting device as claimed in claim 1, wherein the heat-dissipating member is a heatsink with a plurality of dissipating fins.

17. The light-emitting device as claimed in claim 1, wherein the light-emitting elements are packaged on the circuit board by a filler

18. The light-emitting device as claimed in claim 16, wherein the filler is plastic, resin or silicon rubber or epoxy resin.

19. The light-emitting device as claimed in claim 1, further comprising a power supply electrically connected with the circuit board for providing power of the light-emitting device.
